(19) United States
(12) Patent Application Publication
(10) Pub. No.: US 2009/0290636 A1
(43) Pub. Date: Nov. 26, 2009

(54) VIDEO ENCODING APPARATUSES AND METHODS WITH DECOUPLED DATA DEPENDENCY

(75) Inventors: Wen-Jun LIU, Hsinchu County (TW); Shih-Chang HU, Hsin-Chu City (TW); Shien-Tai PAN, Laguna Niguel, CA (US)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: MEDIATEK INC., Hsin-Chu (TW)

(21) Appl. No.: 12/123,500

(22) Filed: May 20, 2008

(51) Int. Cl. H04N 7/26

(52) U.S. Cl. 375/240.2; 375/240.24; 375/E07.026

(57) ABSTRACT

Video encoding apparatuses and methods with decoupled data dependency are provided. An embodiment of a method for video encoding with decoupled data dependency contains at least steps as follows. Data generated from a macroblock of a previous frame is acquired. At least one reference parameter for a macroblock of a current frame is determined according to the acquired data. The macroblock of the current frame is encoded according to the determined reference parameter to generate an output bitstream.

### BACKGROUND OF THE INVENTION

1. Field of the Invention

The invention relates to video signal processing, and more particularly to video encoding apparatuses and methods.

2. Description of the Related Art

An electronic apparatus with a video camera, such as a feature mobile phone or a surveillance application, is increasingly used to capture motion pictures to obtain real-time video data. A video camera pixel sensor first captures successive pictures to obtain a series of raw video frames. To reduce raw video frame data amount, the raw video frames must be compressed to obtain specifically formatted encoded video data, such as MPEG-2 or MPEG-4. The compression process is referred to as video encoding. The video data generated from video encoding comprises a series of compressed video frames. Each compressed video frame typically comprises a plurality of macroblocks made up of a certain number of pixels, such as 16×16 or 8×8 pixels. Each of the macroblocks is encoded sequentially during the compression process.

Referring to FIG. 1, a block diagram of a conventional video encoding apparatus 100 for video encoding is shown. The video encoding apparatus 100 comprises a motion estimation module 102, a quantization parameter (QP) estimation and mode decision module 104, a compression module 106, a decoding module 108, and a rate control module 1 10. A raw video frame S0 is first delivered to the motion estimation module 102. The motion estimation module 102 then performs motion estimation on each macroblock to obtain motion estimation data S1. According to the motion estimation data S1, the QP estimation and mode decision module 104 then determines a quantization parameter as well as a coding mode S2 to quantize the current macroblock of the raw frame S0.

If the motion estimation module 102 successfully finds a reference macroblock in the reference frame S4 with great approximation to the current macroblock of the raw frame S0, the compression module 106 sequentially performs motion compensation, discrete cosine transformation (DCT), quantization, and variable length encoding (VLE) on the current macroblock of the raw frame S0 to obtain a compressed macroblock S3.

If the motion estimation module 102 does not successfully find a reference macroblock with great approximation, the QP estimation and mode decision module 104 performs a mode decision operation to switch the compression module 106 to a direct mode (usually called Intra mode.) In the direct mode, the compression module 106 performs DCT, quantization, and VLE on the current macroblock to obtain a compressed macroblock S3.

Increasing the quantization parameter S2 reduces the data amount of the compressed macroblock. To keep constant the data rate of the compressed macroblocks, the rate control module 110 must determine information S5 according to the accumulated data amount of the previous compressed macroblock to dynamically adjust the quantization parameter S2 of the QP estimation and mode decision module 104. In addition, each of the encoded macroblocks is decoded by the decoding module 108. The decoded versions form the reference frame S4, used for the motion estimation module 102 when processing the next raw frame S0.

All the modules 102˜110 of the video encoding apparatus 100 processes the encoding of a frame macroblock by macroblock thereof Because the video encoding apparatus 100 processes one macroblock on the basis of the results of encoding prior macroblocks, the modules 102˜110 of the video encoding apparatus 100 must operate consecutively. Therefore, operations of the modules 102˜110 may either need high-speed implementation with a high cost or introduce poor performance when adopting implementation with a limited computation power. Thus, the invention introduces video encoding apparatuses and methods with decoupled data dependency to reduce the cost as well as increase the performance.

### BRIEF SUMMARY OF THE INVENTION

Video encoding apparatuses and methods with decoupled data dependency are provided. An embodiment of a method for video encoding with decoupled data dependency contains at least steps as follows. Data generated from a macroblock of a previous frame is acquired. At least one reference parameter for a macroblock of a current frame is determined according to the acquired data. The macroblock of the current frame is encoded according to the determined reference parameter to generate an output bitstream.

An embodiment of an apparatus for video encoding with decoupled data dependency contains at least a buffer, a second-stage processing module and a compression module. The buffer stores data generated from a macroblock of a previous frame. The second-stage processing module, coupled to the buffer, acquires the data from the buffer and determines at least one reference parameter for a macroblock of a current frame according to the acquired data. The compression module, coupled to the parameter determination module, encodes the macroblock of the current frame according to the determined reference parameter to generate an output bitstream.

An embodiment of an apparatus for video encoding with decoupled data dependency contains at least a compression module, a buffer, a first-stage processing module, a second-stage processing module, a first selector and a second selector. The first-stage processing module performs a first set of operations on a macroblock of a current frame to generate results. The second-stage processing module, coupled to the buffer, acquires data generated from a macroblock of a previous frame from the buffer or the generated results from the first-stage processing module, and performs a second set of operations according to the acquired data or the generated results to determine at least one reference parameter. The first selector, coupled between the first-stage processing module, the second-stage processing and the buffer, transmits the generated results from the first-stage processing unit to either the second-stage processing unit or the buffer. The second selector, coupled between the second-stage processing module, the buffer and the compression module, transmits encoding results of the macroblock of the current frame from the compression module to either the buffer or the second-stage processing unit.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a block diagram of a conventional video encoding apparatus for video encoding;

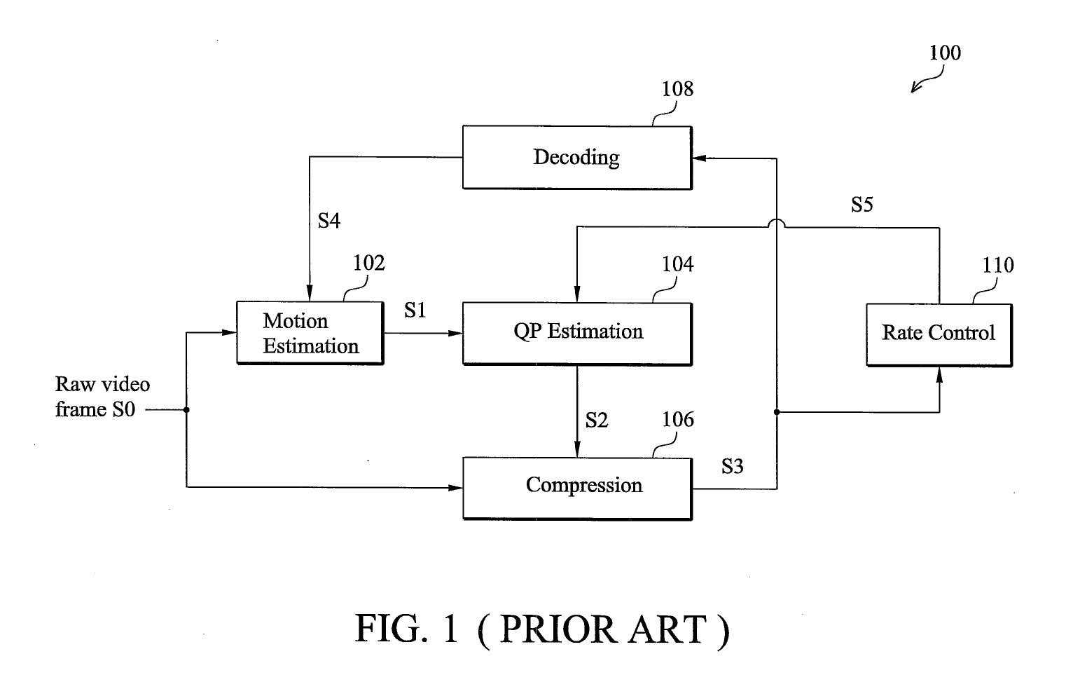

FIG. 2 is a block diagram of a video encoding apparatus according to an embodiment of the invention;

FIGS. 3A and 3B are schematic diagrams of operation of buffers in second processing mode according to an embodiment of the invention;

FIG. 4A is a timing datagram of frame processing of the embodiment of video encoding apparatus of FIG. 2 in first processing mode;

FIG. 4B is a timing datagram of frame processing of the embodiment of video encoding apparatus of FIG. 2 in second processing mode; and

FIG. 5 is a block diagram of a video encoding apparatus according to an embodiment of the invention.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

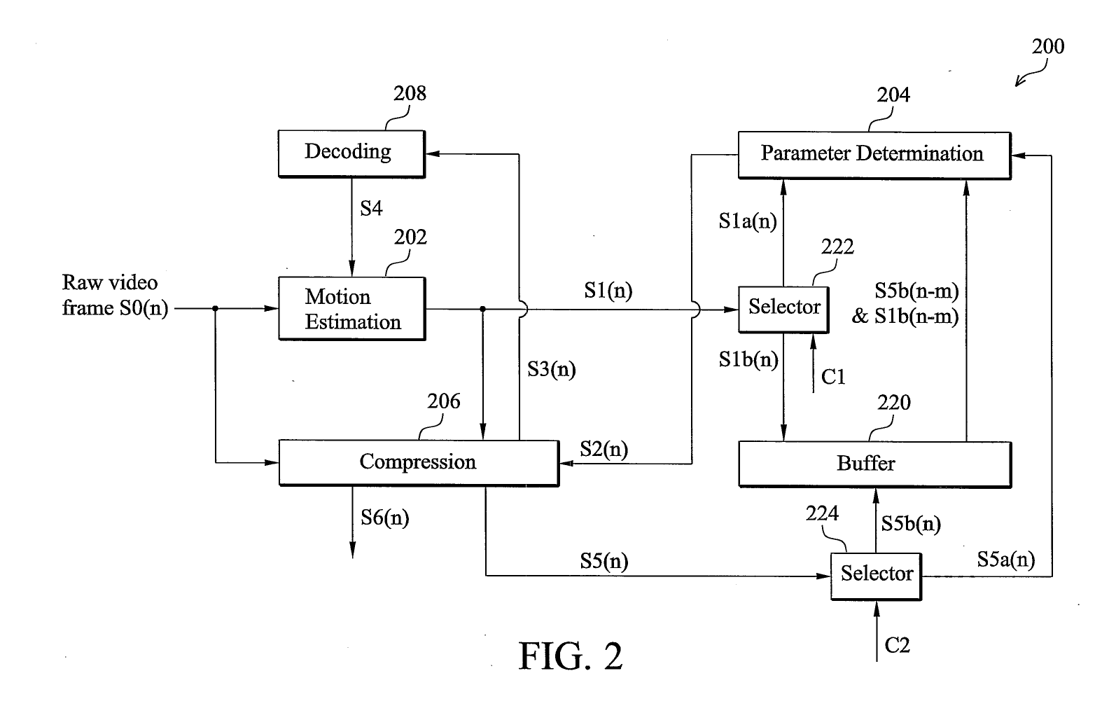

Referring to FIG. 2, a block diagram of a video encoding apparatus 200 is introduced according to an embodiment of the invention. The video encoding apparatus 200 comprises a motion estimation module 202, a parameter determination module 204, a compression module 206, a decoding module 208, a buffer 220, and selectors 222 and 224. The video encoding apparatus 200 may operate in two processing modes with control of the selectors 222 and 224.

In either the first or second processing mode, when encoding a current frame being a predicted frame (P-frame), the motion estimation module 202 performs motion estimation to obtain motion estimation data of the current frame S1(n), wherein n is a frame index representing a current frame. In one embodiment, the motion estimation data for each macroblock is generated with reference to a reconstructed frame S4, also called a reference frame. Motion estimation is used to eliminate the large amount of temporal redundancy that exists in video sequences. Motion estimation may choose different block sizes, and may vary the size of the blocks within a given frame, where the chosen block size may be equal or less than the macroblock size. Each block is compared to a block in the reference frame using some error measure, and the best matching block is selected. The search is conducted over a predetermined search area. To evaluate the estimation of matches between prediction macroblocks in the reference frame and macroblocks being encoded in the current frame, various matching criteria, such as CCF (cross correlation function), PDC (pel difference classification, MAD (mean absolute difference), MSD (mean squared difference), IP (integral projection) and the like may be employed. A motion vector denoting the displacement of the block in the reference picture with respect to the block in the current frame, is determined. The motion estimation module 202 further subtracts the matched block of the reference frame S4 from the current block of the current frame S0. The difference is then called residual data and typically contains less energy (or information) than the original block. The motion estimation module 202 may further calculates activity (also called complexity) and average luminance for each macroblock of the current frame S0(n).

The selector 222 then determines whether the motion estimation data for each macroblock of the current frame S1(n) is delivered to the parameter determination module 204 or the buffer 220 according to a control signal C1. The delivered motion estimation data for each macroblock may contain at least the predicted motion vectors, residual data, activity, average luminance, or any combinations thereof. In the first processing mode, the selector 222 delivers the motion estimation data S1(n) macroblock by macroblock to the parameter determination module 204 as the motion estimation data S1a(n), wherein n is a frame index representing a current frame. The motion estimation module 202, the parameter determination module 204, the compression module 206, and the decoding module 208 need a higher data processing speed to sync with each other. In the second processing mode, the motion estimation module 202, the parameter determination module 204, and the compression module 206, and the decoding module 208 may have a lower data processing speed. The selector 222 delivers the motion estimation data S1(n) to the buffer 220 as the motion estimation data S1b(n) for storage and the stored motion estimation data is utilized to determine reference parameters for a subsequent frame.

In the first processing mode, the parameter determination module 204 performs mode decision, QP estimation, rate control and the similar according to at least the motion estimation data S1a(n) and actual consumption of bits after compressing the prior macroblock S5a(n), and then determines parameters S2(n) such as a quantization parameter (Qp value), an encoding mode and the like, for compressing each macroblock of the current raw frame S0. The parameter determination module 204 may determine whether the current macroblock is encoded as the intra mode or as the inter mode according to the certain decision rules considering the described residual data, activity and average luminance with predefined thresholds. The parameter determination module 204 may utilize a constant bit rate (CBR) for a series of frames regardless of the complexity of each video interval to determine a Qp value. Bit rate is used to determine the video quality and defines how much physical space that one second of video requires in bits. CBR technique assumes equal weighting of bit distribution among the series of frames which results in reducing the degree of freedom of the encoding task. The CBR encoding outputs a bitstream with an output rate kept at almost the same rate regardless of the content of the input video. As a result, for a video interval with simple content, the encoding quality will be good; however, for a video interval with complex content, the encoding quality will be poor. In CBR, the parameter determination module 204 may determine a bit budget for each macroblock according to a frame bit budget regardless of complexity of the current frame and actual consumption of bits after compressing former macroblocks S5a(n). Subsequently, a Qp value is determined to achieve the determined bit budget. The parameter determination module 204 may employ a variable birate (VBR) for a series of frames with consideration of the complexity of each video interval to determine a Qp value. VBR technique produces non-constant output bit-rate during a period of time, and a complex frame consumes a higher bit rate than that of a plain frame. CBR control or VBR control embedded in the the parameter determination module 204 is utilized to control quantization values (e.g. quantization step size) to enable the output bit rate or bit rates to meet a target bit rate or varied target bit rates. In VBR, the parameter determination module 204 may determine a bit budget for each macroblock according to a frame bit budget with considerations of complexity of the current frame and actual consumption of bits after compressing the prior macroblock S5a(n). Subsequently, a Qp value is determined to achieve the determined bit budget.

In either the first or second processing mode, the determined parameters for each macroblock of the current frame are transmitted to the compression module 206 as reference parameters of the current frame S2(n). When a macroblock is determined to be encoded as the inter mode by the parameter determination module 204, the compression module 206 then sequentially performs discrete cosine transformation (DCT), quantization and variable length encoding (VLE) on the residual data of the macroblock of the raw frame S0 according to the reference parameters S2(n) to generate an output bitstream of the current frame S6(n). When a macroblock is determined to be encoded as the intra mode by the parameter determination module 204, the compression module 206 then sequentially performs DCT, quantization and VLE on the raw data of the macroblock of the raw frame S0 according to the reference parameter S2(n) to generate an output bitstream S6(n). In DCT, pixel data (raw data or residual data) of each macroblock of the current frame is transformed into a set of frequencies (also called DCT coefficients) by a forward discrete cosine transform (FDCT) formula. In quantization, the compression module 206 may calculate a luminance base table and a chrominance base table based on the determined Qp value and quantize the transformed DCT coefficients of each macroblock with reference to the calculated luminance or chrominance base table. In VLE, all quantized DCT coefficients of macroblocks may be sequentially encoded by a zero run-length encoding (RLE) method to generate a RLE code stream and the generated RLE code stream may be encoded by an entropy encoding method (e.g. Huffman encoding) to generate a variable length coding (VLC) bitstream as the output S6(n).

In addition, in either the first or second processing mode, the quantized DCT coefficients of macroblocks of the current frame S3(n) are also transmitted to the decoding module 208. When a macroblock is determined to be encoded in the inter mode, the decoding module 208 then sequentially performs inverse-quantization (IQ), inverse discrete cosine transformation (IDCT) and block replacement on the de-quantized DCT coefficients of macroblocks S3(n) according to the reference parameter S2(n) to reconstruct a frame S4 for future reference. When a macroblock is determined to be encoded in the intra mode, the decoding module 208 then sequentially performs IQ and IDCT on the quantized DCT coefficients of macroblocks S3(n) according to the reference parameter S2(n) to reconstruct a frame S4 for future reference. In IQ, the decoding module 208 may calculate a luminance base table and a chrominance base table based on the determined Qp value and de-quantize the quantized DCT coefficients of macroblocks of the current frame with reference to the calculated luminance and chrominance base tables to generate de-quantized DCT coefficients. In IDCT, the decoding module 208 may transform each de-quantized DCT coefficient of macroblocks of the current frame into decoded pixel data by an inverse discrete cosine transform (IDCT) formula. In block replacement, the decoding module 208 may add matched macroblocks of a reference frame S4(n-1) to predicted macroblocks of the current frame S0 according to the determined motion vector.

The selector 224 then determines whether actual bit consumption after encoding each macroblock of the current frame S5(n) is delivered to the parameter determination module 204 or the buffer 220 according to a control signal C2. In the first processing mode, the selector 222 delivers the actual bit consumption S5(n) macroblock by macroblock to the parameter determination module 204 as the feedback data S5a(n). In the second processing mode, the selector 222 delivers the actual bit consumption S5(n) to the buffer 220 as the feedback data S5b(n) for storage and the stored actual bit consumption for each macroblock is utilized to determine reference parameters for a subsequent frame.

In the second processing mode, the selector 222 delivers the motion estimation data S1b(n) to the buffer 220 according to a control signal C1. The buffer 220 then stores the motion estimation data S1b(n) macroblock by macroblock. The parameter determination module 204 retrieves the motion estimation data S1b(n-m) and actual bit consumption of a corresponding macroblock of a previous frame S5b(n-m) from the buffer 220, performs mode decision for each macroblock of the current frame according to the retrieved data, where m is an integer greater than or equal to one. Details of operations of the parameter determination module 204 in the second processing mode to perform mode decision, QP estimation and rate control may be deduced by the operations in the first processing mode, and are briefly described herein for brevity. However, the mode decision, QP estimation and rate control are performed based on reference parameters and actual bit consumption of each macroblock of the previous frame (n-m) instead of the current frame (n). Thus, in the second processing mode, first part of hardware circuits containing the motion estimation module 202, compression module 206 and decoding module 208, and second part of hardware circuits containing the parameter determination module 204 can be pipelined. Moreover, the interference between operations of the first and second parts can be dramatically reduced.

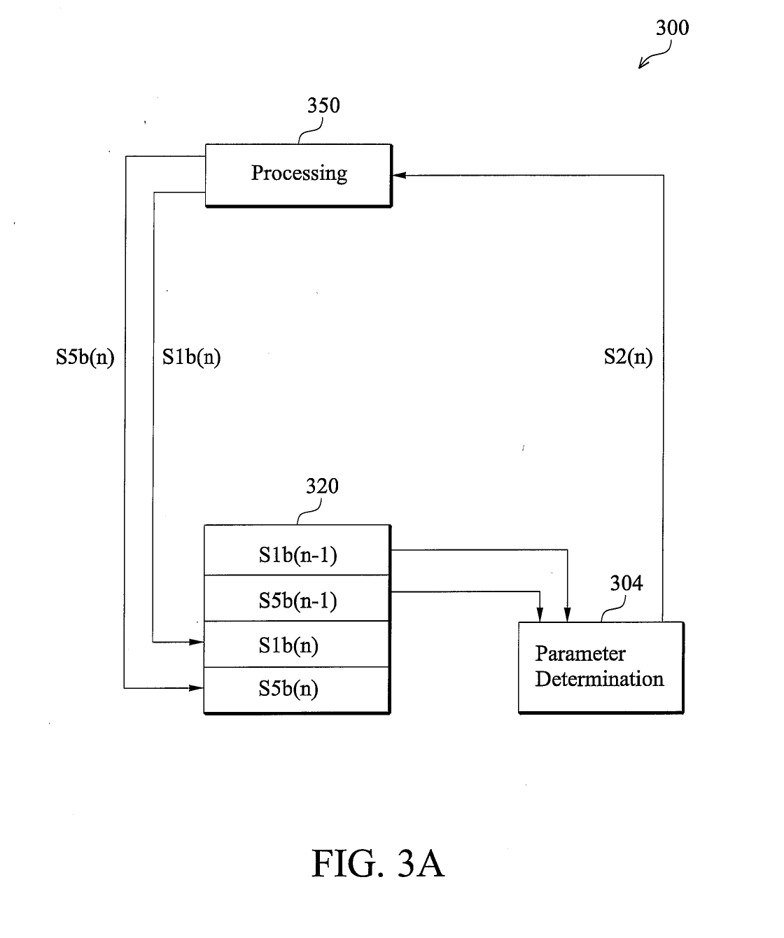

Referring to FIGS. 3A and 3B, schematic diagrams of exemplary operations to access a buffer 320 in the second processing mode according to the invention are shown. The buffer 320 and a parameter determination 304 respectively represent the buffer 220 and the parameter determination module 204 shown in FIG. 2. A processing module 350 represents the motion estimation module 202, the compression module 206 or the decoding module 208 shown in FIG. 2, or any combination thereof. When compressing each macroblock of a raw frame S0, the parameter determination module 304 acquires motion estimation data of a corresponding macroblock of a previous frame S1b(n-1) or previous frames S1b(n-1) and S1b(n-2) and actual bit consumption after compressing the prior macroblock of a previous frame S5b(n-1) or previous frames S5b(n-1) and S5b(n-2) from the buffer 320 to generate reference parameters such as a quantization parameter (Qp value), an encoding mode and the like S2(n). The processing module 350 compresses and reconstructs each macroblock of the current frame according to the reference parameters S2(n) provided by the parameter determination module 304. During motion estimation and compression of each macroblock of the current frame, the processing module 350 generates and stores motion estimation data of the current frame S1b(n) in the buffer 320, as well as, determines and stores actual bit consumption of the current frame S5b(n) in the buffer 320 for future reference.

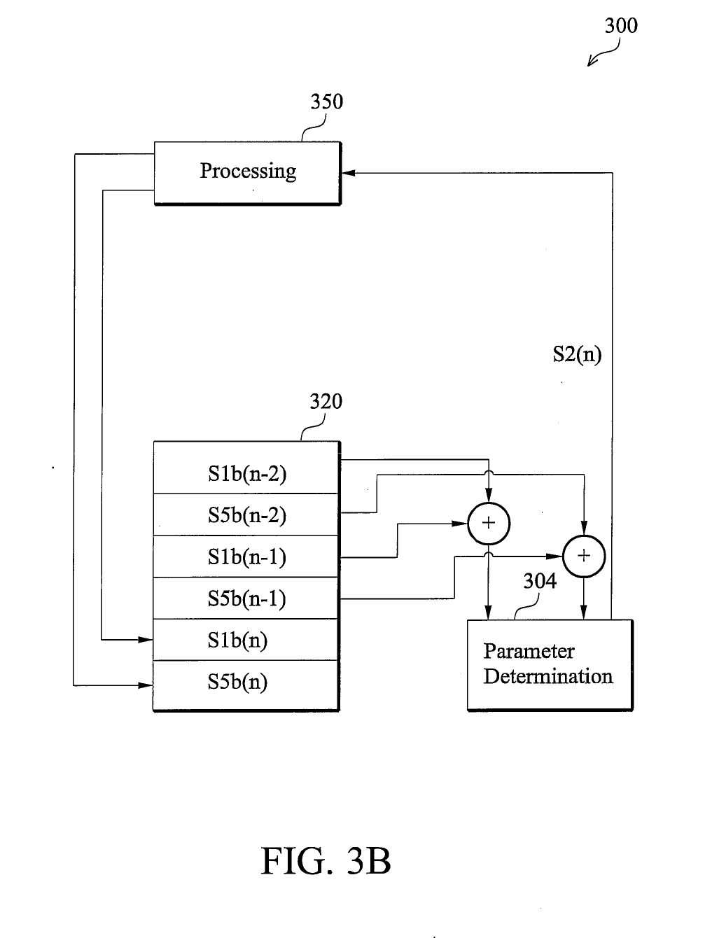

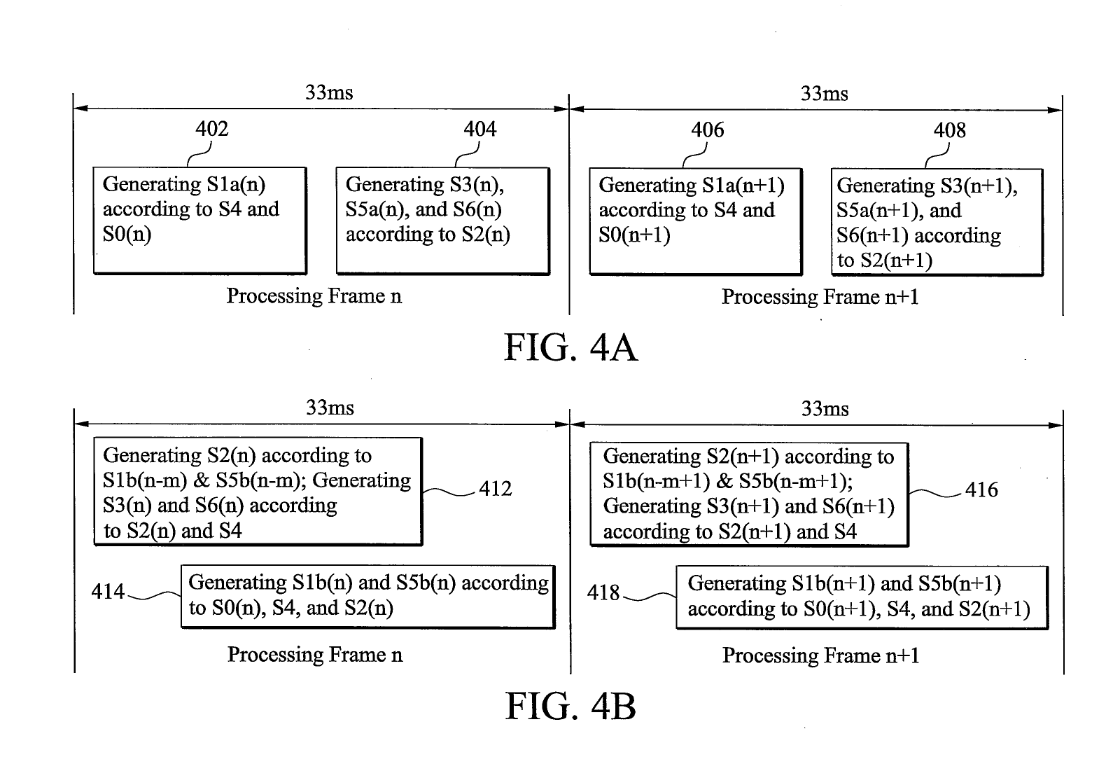

Referring to FIG. 4A, a timing datagram of frame processing of the embodiment of video encoding apparatus 200 in the first processing mode is shown. The video encoding apparatus 200 may process each raw frame within a budget threshold. In an embodiment, the video encoding apparatus 200 processes 30 raw frames per second, and a time budget for processing each frame is 33 ms. For example, during operations 402, motion estimation data for each macroblock of a current raw frame S1a(n) is generated in the first processing mode according at least to a prior reconstructed frame S4 and the current raw frame S0(n), wherein n is a frame index. During operations 404, reference parameters for each macroblock of the current frame S2(n) are generated according at least to the motion estimation data S1a(n) and actual bit consumption after encoding the prior macroblock S5a(n), as well as, output bitstream S6(n) and quantized DCT coefficients S3(n) are generated according at least to the reference parameters S2(n) in the first processing mode. The video encoding apparatus 200 therefore must complete both operations 402 and 404 within a time period of 33 ms. It is to be understood that, in the first processing mode, the mentioned motion estimation, frame reconstruction, parameter determination and actual compression for a frame form a close loop and are highly interrelated.

Referring to FIG. 4B, a timing datagram of frame processing of the embodiment of video encoding apparatus 200 in the second processing mode is shown. For example, during operations 412, reference parameters for each macroblock of the current frame S2(n) are generated according at least to the motion estimation data of the corresponding macroblock of a previous frame S1b(n-m) and actual bit consumption after encoding the prior macroblock of the same previous frame S5b(n-m), as well as, output bitstream S6(n) and quantized DCT coefficients S3(n) are generated according at least to the reference parameters S2(n) in the second processing mode, wherein n is a frame index and m is an integer greater than or equal to one. During operations 414, motion estimation data of each macroblock of the current frame S1b(n) is generated for future reference according at least to the current frame S0(n) and a reconstructed frame S4, as well as, the actual bit consumption after encoding the current macroblock of the current frame S5b(n) is generated for future reference according at least to the reference parameters S2(n).The video encoding apparatus 200 therefore must also complete both operations 412 and 414 within a time period of 33 ms. In the second processing mode, because generation of reference parameters for each macroblock of the current frame refers to previously buffered motion estimation data and actual bit consumption after encoding the prior macroblock of a previous frame instead of that of the current frame, certain data dependencies are broken and a portion of the operations 412 and 414 can be simultaneously performed.

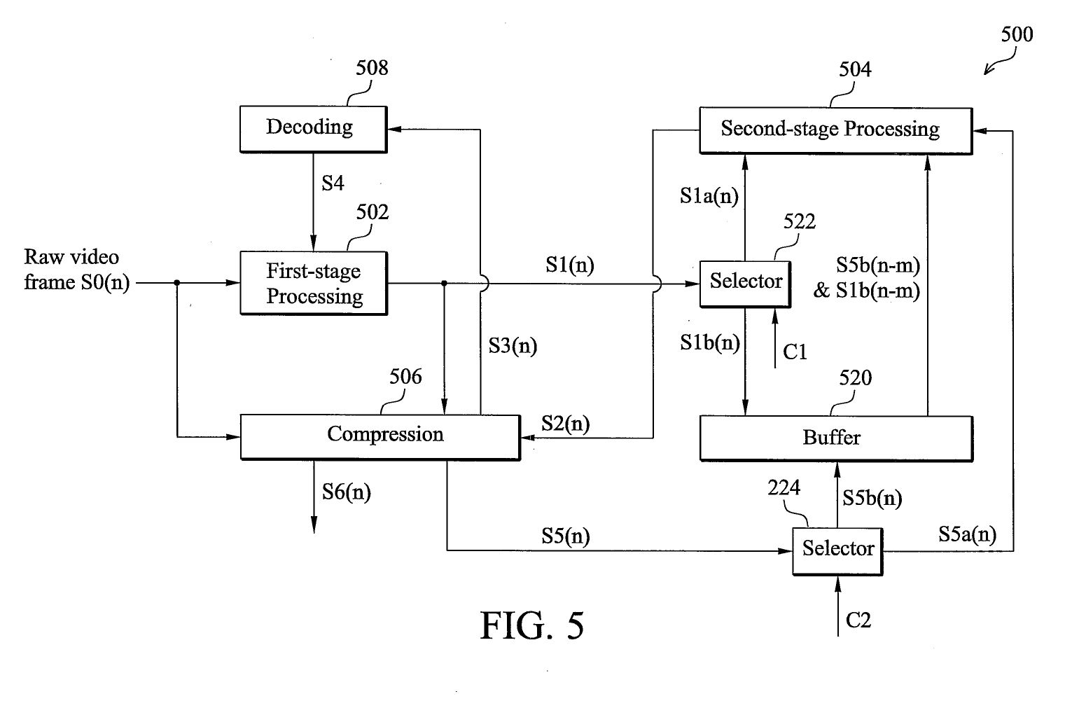

The structure of the video encoding apparatus 200 can be adjusted according to system requirements. Referring to FIG. 5, a block diagram of a video encoding apparatus 500 according to an embodiment of the invention is shown. The video encoding apparatus 500 comprises a first-stage processing module 502, a second-stage processing module 504, a compression module 506, a decoding module 508, a buffer 520, two selectors 522 and 524. Except for the first-stage processing module 502 and a second-stage processing module 504, the functions of all the modules of the video encoding apparatus 500 are similar to the functions of the video encoding apparatus 200 in FIG. 2. In an embodiment, the first-stage processing module 502 contains dedicated hardware circuits with higher data processing capability, and the second-stage processing module 504 a general-purpose processor executing firmware/software code with lower data processing capability.

In the second processing mode, the operations such as motion estimation, Qp estimation, mode decision, and rate control can be selectively designed in the first-stage processing module 502 and the second-stage processing module 504. For example, when the video encoding apparatus 500 is required to generate high quality bitstream S6, such as a camera recording application or a smart phone with a camera function, the first-stage processing module 502 therefore may bear heavier data processing load to increase encoding quality resulting in increased hardware cost. In an embodiment, the first-stage processing module 502 performs motion estimation and mode decision according to information regarding the current frame and a prior reconstructed frame, while the second-stage processing module 504 performs Qp estimation and rate control according to reference parameters generated from a previous frame.

For example, the video encoding apparatus 500 is not required to generate high quality bitstream S6, such as a surveillance system. The second-stage processing module 504 therefore may bear heavier data processing load to reduce hardware cost resulting in lower encoding quality. In an embodiment, the first-stage processing module 502 performs motion estimation according to information regarding the current frame and a prior reconstructed frame, while the second-stage processing module 504 performs Qp estimation, mode decision and rate control according to reference parameters generated from a previous frame.

In some embodiments, for reducing circuit complexity and die size, the selectors 522 and 524 may be removed from the entire apparatus and only the described second processing mode is operated.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A method for video encoding with decoupled data dependency, comprising:
acquiring data generated from a macroblock of a previous frame;
determining at least one reference parameter for a macroblock of a current frame according to the acquired data; and
encoding the macroblock of the current frame according to the determined reference parameter to generate an output bitstream.

2. The method as claimed in claim 1, wherein the index of current frame is n, the index of previous frame is n-m, and m represents an integer being greater than or equal to 1.

3. The method as claimed in claim 1, wherein the reference parameter comprises a bit budget determined according at least to actual consumption of bits after compressing the prior macroblocks of a previous frame.

4. The method as claimed in claim 3, wherein the reference parameter comprises a quantization value determined according to the bit budget and the encoding step further:
calculates a luminance base table and a chrominance base table based on the quantization value and quantizes a plurality of discrete cosine transform (DCT) coefficients of the macroblock of the current frame.

5. The method as claimed in claim 1, wherein the reference parameter indicates a determination of an intra mode or an inter mode according to motion estimation results of the macroblock of the previous frame and the encoding step further:
performs discrete cosine transform (DCT), quantization and variable length encoding (VLC) on the macroblock of the current frame when the reference parameter indicates a determination of the intra mode; and
performs motion compensation, DCT, quantization and VLE on the macroblock of the current frame when the reference parameter indicates a determination of the inter mode.

6. The method as claimed in claim 1, wherein the data is acquired from a buffer.

7. The method as claimed in claim 6, further comprising:
generating data during performing motion estimation on the marcoblock of the current frame and encoding of the macroblock of the current frame; and
storing the generated data in the buffer for reference by a macroblock of a subsequent frame.

8. An apparatus for video encoding with decoupled data dependency, comprising:
a buffer for storing data generated from a macroblock of a previous frame;
a second-stage processing module, coupled to the buffer, for acquiring the data from the buffer and determining at least one reference parameter for a macroblock of a current frame according to the acquired data; and
a compression module, coupled to the parameter determination module, for encoding the macroblock of the current frame according to the determined reference parameter to generate an output bitstream.

9. The apparatus as claimed in claim 8, wherein the compression module encodes the current frame according to motion estimation results between the macroblock of the current frame and a macroblock of a reconstructed frame.

10. The apparatus as claimed in claim 8, further comprising:
a first-stage processing module, coupled to the buffer, for performing a first set of operations on the macroblock of the current frame to generate results and storing the results in the buffer, which is to be referenced by a macroblock of a subsequent frame,
wherein the second-stage processing module performs a second set of operations to determine the reference.

11. The apparatus as claimed in claim 10, wherein the first-stage processing module contains dedicated hardware circuits and the second-stage processing module contains a general-purpose processor executing firmware/software code.

12. The apparatus as claimed in claim 10, wherein the first set of operations comprises motion estimation and mode decision, and the second set of operations comprises Qp estimation and rate control.

13. The apparatus as claimed in claim 10, wherein the first set of operations comprises motion estimation, and the second set of operations comprises Qp estimation, mode decision and rate control.

14. The apparatus as claimed in claim 10, wherein the compression module, further coupled to the buffer, generates data during encoding of the macroblock of the current frame and stores the generated data in the buffer for reference by the macroblock of the subsequent frame.

15. The apparatus as claimed in claim 14, wherein the generated data comprises actual bit consumption for encoding the macroblock of the current frame.

16. An apparatus for video encoding with decoupled data dependency, comprising:
a compression module;
a buffer;
a first-stage processing module for performing a first set of operations on a macroblock of a current frame to generate results;
a second-stage processing module, coupled to the buffer, for acquiring data generated from a macroblock of a previous frame from the buffer or the generated results from the first-stage processing module, and performing a second set of operations according to the acquired data or the generated results to determine at least one reference parameter;
a first selector, coupled between the first-stage processing module, the second-stage processing and the buffer, for transmitting the generated results from the first-stage processing unit to either the second-stage processing unit or the buffer; and
a second selector, coupled between the second-stage processing module, the buffer and the compression module, for transmitting encoding results of the macroblock of the current frame from the compression module to either the buffer or the second-stage processing unit.

17. The apparatus as claimed in claim 16, wherein when the apparatus operates in a first processing mode, the first selector is directed to deliver the generated results from the first-stage processing module to the second-stage processing module and the second selector is directed to transmit the encoding results from the compression module to the second-stage processing module; and when the apparatus operates in a second processing mode, the first selector is directed to deliver the generated results from the first-stage processing module to the buffer and the second selector is directed to transmit the encoding results from the compression module to the buffer.

18. The apparatus as claimed in claim 16, wherein the compression module encodes the macroblock of the current frame according to the generated reference parameter by the second-stage processing module.

19. The apparatus as claimed in claim 17, wherein the second-stage processing module performs the second set of operations according to the generated results when the apparatus operates in the first processing mode, and the second-stage processing module performs the second set of operations according to the acquired data from the buffer when the apparatus operates in the second processing mode.

20. The apparatus as claimed in claim 16, wherein the first-stage processing module contains dedicated hardware circuits and the second-stage processing module contains a general-purpose processor executing firmware/software code.
